(19) United States
(12) Patent Application Publication
(10) Pub. No.: US 2001/0021940 A1
(43) Pub. Date: Sep. 13, 2001

(54) Method of updating reflection coefficients of lattice filter and apparatus for updating such reflection coefficients

(75) Inventors: Kensaku Fujii, Kawasaki (JP); Juro Ohga, Kamakura (JP)

Correspondence Address: HELFGOTT & KARAS, P.C., 60th FLOOR, EMPIRE STATE BUILDING, NEW YORK, NY, 10118, US

(73) Assignee: FUJITSU LIMITED

(21) Appl. No.: 09/767,560

(22) Filed: Jan. 23, 2001

(30) Foreign Application Priority Data
Mar. 10, 2000 (JP) 2000-067787

(51) Int. Cl. G06F 17/10

(52) U.S. Cl. 708/318; 708/322

(57) ABSTRACT

A method of updating reflection coefficients of a lattice filter is provided, which method includes the step of updating backward reflection coefficients by employing forward reflection coefficients which are updated so that a forward prediction error of a last stage of the lattice filter is minimized.

### BACKGROUND OF THE INVENTION

1. Field of the Invention

The present invention generally relates to methods of updating reflection coefficients of lattice filters and apparatus for updating such reflection coefficients, and more particularly to a method of updating reflection coefficients of a lattice filter and an apparatus for updating such reflection coefficients when the lattice filter is employed as an adaptive filter.

2. Description of the Related Art

FIG. 1 is a diagram showing a structure of a lattice filter. The lattice filter includes a predetermined number of stages of unit elements 100-n (n=1, 2, . . . ) so that a unit element 100-n+1 is dependently connected to a unit element 100-n, as shown in FIG. 1, where a unit element 100-2 is independently connected to a unit-element 100-1. The unit element 100-1 includes a multiplier 110 which multiplies a forward prediction error fⱼ(i−1) by a backward reflection coefficient αⱼ(i), a multiplier 120 which multiplies a backward prediction error bⱼ(i−1) by a forward reflection coefficient βⱼ(i), a delay element 130 which delays the backward prediction error bⱼ(i−1) by one sampling period, and adders 140 and 150. A merit of the lattice filter lies in that the stability of the lattice filter can be judged by checking only the magnitude of a reflection coefficient. That is, when both of the backward and forward reflection coefficients αⱼ(i) and βⱼ(i) shown in FIG. 1 are less than one, the lattice filter is stable.

However, it is a problem in putting the lattice filter into practical use that the lattice filter is required to perform a large number of division operations. In the lattice filter, both of the backward and forward reflection coefficients αⱼ(i) and βⱼ(i) are calculated as cross-correlation coefficients between the forward prediction error fⱼ(i−1) and the backward prediction error bⱼ(i−1). Therefore, in every calculation of the above-described reflection coefficients, division operations for normalization based on power are required. On the other hand, in the case of employing a finite impulse response (FIR) filter as an adaptive filter and employing the normalized least mean squares (NLMS) algorithm as an algorithm for calculating the coefficients of the FIR filter, only one division operation is required to calculate all the coefficients. Thus, in the case of employing the lattice filter, the number of division operations required to calculate all the coefficients is quite large compared with the case of employing the FIR filter.

Further, as an adaptive filter for identifying a characteristic or a reverse characteristic of an unknown system, the lattice filter only performs a linear prediction analysis of an input reference signal. Therefore, the characteristic or reverse characteristic of the unknown system is prevented from being obtained from reflection coefficients obtained as a result of the linear prediction analysis.

A variety of methods of calculating the reflection coefficients of the lattice filter are known, and a detailed description of the methods is given in “Adaptive Filter Theory” by Haykin, Simon, translated by Takebe, Tuyoshi, published by Gendaikougakusha. However, any of the methods is basically the time-update recursion. Therefore, a description will here be given of the time-update recursion, which is a conventional method of calculating reflection coefficients. According to the time-update recursion, both of the backward and forward reflection coefficients αⱼ(i) and βⱼ(i) can be obtained as follows as the cross-correlation coefficients between the forward prediction error fⱼ(i−1) and the backward prediction error bⱼ(i−1).

First, calculations are made in accordance with below-described formulas in which a constant ρ<1.

Cⱼ(i)=fⱼ(i−1)bⱼ₋₁(i−1)+ρCⱼ₋₁(i) (1)

Pⱼ(i)=fⱼ²(i−1)+ρPⱼ₋₁(i) (2)

Qⱼ(i)=bⱼ₋₁²(i−1)+ρQⱼ₋₁(i) (3)

Next, calculations are made in accordance with below-described formulas.

αⱼ(i)=Cⱼ(i)/Pⱼ(i) (4)

βⱼ(i)=Cⱼ(i)/Qⱼ(i) (5)

From the calculations according to the above-described formulas, both of the backward and forward reflection coefficients αⱼ(i) and βⱼ(i) can be obtained.

Here, the constant ρ is defined by a formula given below, letting the number of the taps of the lattice filter be M, so as to correspond to a later-described step size μ in the NLMS algorithm.

ρ=1−μ/M

As is apparent from the formulas (4) and (5), in order to calculate both of the backward and forward reflection coefficients αⱼ(i) and βⱼ(i) of the lattice filter, the number of required division operations should be double the number of the taps of the lattice filter. Therefore, it is a problem in realizing the lattice filter that such a large number of division operations are required. Since a divider circuit is large in size, realizing the divider circuit in the form of hardware inevitably requires the hardware to be large in size as well. Further, if a division operation is realized in the form of software by means of a digital signal processor (DSP), a large amount of data should be processed.

Moreover, the lattice filter is prevented from being employed as an adaptive filter for a system identification system shown in FIG. 2, which system is used for estimating a characteristic of an unknown system 200. The system identification system shown in FIG. 2 includes the unknown system 200, an adaptive filter 210, which is adapted to the same characteristic as that of the unknown system, a coefficient update circuit 220, an adder 230, which adds an equivalent noise to the output of the unknown system, and a subtracter 240, which calculates a difference between the output of the adder 230 and the output of the adaptive filter 210. The system identification system estimates the characteristic of the unknown system 200 by calculating the coefficients of the adaptive filter 210 in the coefficient update circuit 220 so that an output Eⱼ of the subtracter 240 is minimized. However, if the lattice filter were employed as the adaptive filter 210 of the system identification system, a reference signal sⱼ is input to respective forward and backward prediction errors fⱼ(0) and bⱼ(0) of the first stage (i=1) of the lattice filter. Therefore, since both of backward and forward reflection coefficients αⱼ(1) and βⱼ(1) are calculated so that the lattice filter performs the linear prediction analysis of the reference signal sⱼ, the characteristic of the unknown system 200 is prevented from being identified. As described above, a system identification method employing the reflection coefficients of the lattice filter has a disadvantage.

### SUMMARY OF THE INVENTION

It is a general object of the present invention to provide a method of updating reflection coefficients of a lattice filter and an apparatus for updating such coefficients.

A more specific object of the present invention is to provide a method of updating reflection coefficients of a lattice filter, which method required a reduced number of division operations required to update the reflection coefficients of the lattice filter, and allows the lattice filter to be employed to identify a characteristic of an unknown system, and an apparatus for updating such coefficients, which apparatus can be used in such a method.

The above objects of the present invention are achieved by a method of updating reflection coefficients of a lattice filter, which method includes the step of updating backward reflection coefficients by employing forward reflection coefficients which are updated so that a forward prediction error of a last stage of the lattice filter is minimized.

According to the above-described method, a number of division operations required to update the reflection coefficients of the lattice filter can be reduced.

The above objects of the present invention are also achieved by a method of updating reflection coefficients of a lattice filter, which method includes the steps of (a) calculating a forward prediction error, (b) updating forward reflection coefficients in accordance with an adaptive algorithm so as to minimize the forward prediction error of a last stage of the lattice filter, and (c) applying the forward reflection coefficients updated in the step (b) to backward reflection coefficients.

According to the above-described method, a number of division operations required to update the reflection coefficients of the lattice filter can be reduced in accordance with the adaptive algorithm.

The above objects of the present invention are also achieved by a method of updating reflection coefficients of a lattice filter, which method includes the step of updating backward reflection coefficients by employing forward reflection coefficients which are updated so as to minimize a difference between a forward prediction error of a last stage of the lattice filter to which an input or output of an unknown system is supplied, and the output or input of the unknown system.

According to the above-described method, a number of division operations required to update the reflection coefficients of the lattice filter can be reduced, and the lattice filter can be employed to identify a characteristic of the unknown system.

The above objects of the present invention are also achieved by a method of updating reflection coefficients of a lattice filter, which method includes the steps of (a) calculating a forward prediction error of the lattice filter to which an input or output of an unknown system is supplied, (b) updating forward reflection coefficients in accordance with an adaptive algorithm so as to minimize a difference between the forward prediction error of a last stage of the lattice filter and the output or input of the unknown system, and (c) applying the forward reflection coefficients updated in the step (b) to backward reflection coefficients.

According to the above-described method, a number of division operations required to update the reflection coefficients of the lattice filter can be reduced, and the lattice filter can be employed to identify an characteristic of the unknown system in accordance with the adaptive algorithm.

The above objects of the present invention are also achieved by an apparatus for updating reflection coefficients of a lattice filter, which apparatus includes a first circuit which calculates a forward prediction error, a second circuit which updates forward reflection coefficients in accordance with an adaptive algorithm so as to minimize the forward prediction error of a last stage of the lattice filter, and a third circuit which applies the forward reflection coefficients updated by the second circuit to backward reflection coefficients.

According to the above-described apparatus, a number of division operations performed in the apparatus for updating the reflection coefficients of the lattice filter can be reduced.

The above objects of the present invention are further achieved by an apparatus for updating reflection coefficients of a lattice filter, which apparatus includes a first circuit which calculates a forward prediction error of the lattice filter to which an input or output of an unknown system is supplied, a second circuit which updates forward reflection coefficients in accordance with an adaptive algorithm so as to minimize a difference between the forward prediction error of a last stage of the lattice filter and the output or input of the unknown system, and a third circuit which applies the forward reflection coefficients updated by the second circuit to backward reflection coefficients.

According to the above-described apparatus, a number of division operations performed in the apparatus to update the reflection coefficients of the lattice filter can be reduced, and the lattice filter is allowed to be employed to identify a characteristic of the unknown system.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a structure of a lattice filter;

FIG. 2 is a diagram showing a system identification system;

FIG. 3 is a diagram showing the principle of the present invention;

FIG. 4 is a diagram showing a forward prediction circuit of the lattice filter of FIG. 1 according to a first embodiment of the present invention;

FIG. 5 is a graph showing results of a simulation of a second embodiment of the present invention, in which embodiment the present invention is applied to a linear prediction analysis;

FIG. 6 is a diagram showing a circuit structure of an unknown system shown in FIG. 2 represented by a finite impulse response (FIR) filter according to a third embodiment of the present invention;

FIG. 7 is a diagram showing a circuit structure of a first stage of a lattice filter corresponding to the FIR filter of FIG. 6;

FIG. 8 is a graph showing results of a simulation of a fourth embodiment of the present invention, in which embodiment the present invention is applied to the system identification system of FIG. 2 in which the unknown system thereof is represented by the FIR filter;

FIG. 9 is a graph showing results of a simulation of a fifth embodiment of the present invention, in which embodiment the unknown system shown in FIG. 2 is represented by the lattice filter; and

FIG. 10 is a diagram showing a system identification system to which the present invention is applied so that a lattice filter is employed as an adaptive filter for identifying a reverse characteristic of an unknown system according to a sixth embodiment of the present invention.

### DETAILED DESCRIPTION OF THE PREFERRED EMBODIMENTS

A description will now be given, with reference to the accompanying drawings, of embodiments of the present invention.

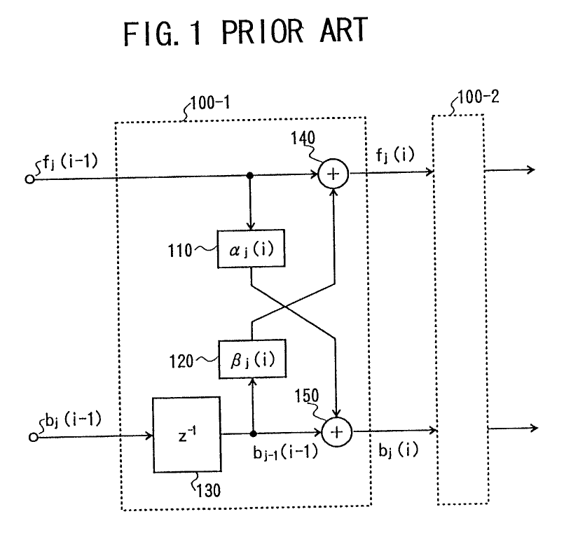

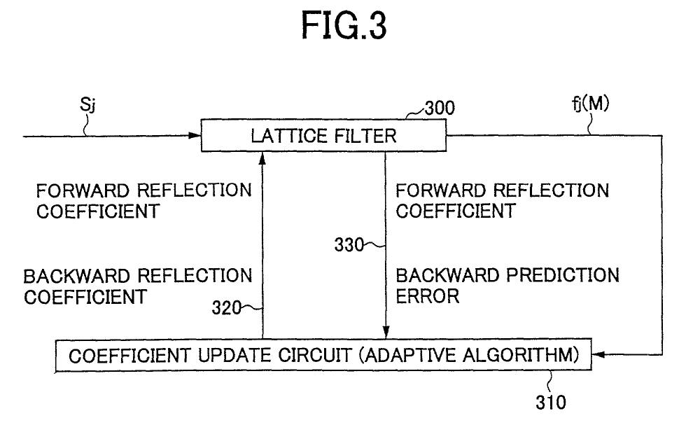

A description will first be given of the principle of the present invention. FIG. 3 is a diagram showing the principle of the present invention. The principle of the present invention includes a lattice filter 300 and a coefficient update circuit 310. The lattice filter 300 has the same structure as the lattice filter shown in FIG. 1. In the coefficient update circuit 310, only the forward and backward prediction errors fⱼ(i−1) and bⱼ(i−1) are employed to calculate a forward prediction error fⱼ(M) of the last stage of the lattice filter 300, and the forward reflection coefficient βⱼ(i) is calculated so that the forward prediction error fⱼ(M) of the last stage is minimized. The backward reflection coefficient αⱼ(i) is provided with a value equal to the forward reflection coefficient βⱼ(i), so that both of the backward and forward reflection coefficients αⱼ(i) and βⱼ(i) are determined.

A description will now be given of a first embodiment of the present invention.

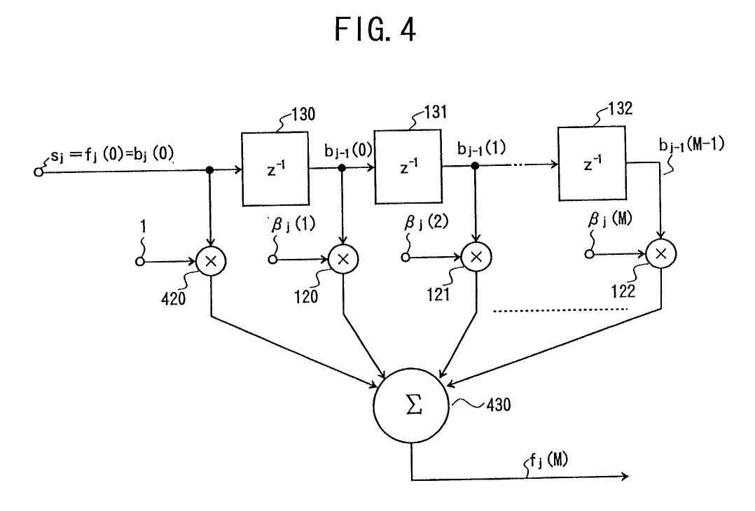

FIG. 4 is a diagram showing a forward prediction circuit of the lattice filter shown in FIG. 1. The forward prediction circuit includes delay elements 130 through 132 each delaying an input backward prediction error signal by one sampling period, multipliers 420 and 120 through 122, and an adder 430. The reference signal sⱼ is input to the delay element 130 and the multiplier 420. The forward reflection coefficient βⱼ(i) is input to each of the multipliers 120 through 122 so as to be multiplied by the backward prediction error bⱼ₋₁(i−1) output from each of the delay elements 130 through 132. The forward prediction error fⱼ(M) of the last stage is the sum of the outputs of the respective multipliers 420 and 120 through 122.

The best forward reflection coefficient βⱼ(i) is a value which minimizes the forward prediction error fⱼ(M) of the last stage. The value can be calculated by means of a conventional adaptive algorithm. For example, in the case of employing the NLMS algorithm as the adaptive algorithm, the forward reflection coefficient βⱼ(i) can be updated in accordance with a below-described formula every time a sampled signal is input.

$${β}_{j + 1} ( i ) = {β}_{j} ( i ) + μ {f}_{j} ( M ) {b}_{j - 1} ( i - 1 ) / {\sum }_{i = 1}^{M} {b}_{j - 1}^{2} ( i - 1 ) \qquad ( 7 )$$

The backward reflection coefficient αⱼ(i) is provided with a value equal to the forward reflection coefficient βⱼ(i) so that both of the backward and forward reflection coefficients αⱼ(i) and βⱼ(i) are updated. Thus, the number of division operations can be reduced to one in every tap.

A description will now be given of a second embodiment of the present invention, in which embodiment the present invention is applied to the linear prediction analysis.

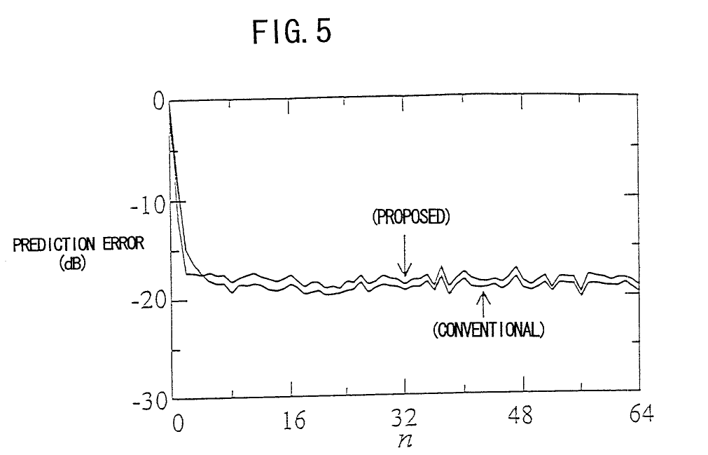

FIG. 5 is a graph showing the results of a simulation of the second embodiment. In the simulation, letting the signal sⱼ of a single sine wave of 500 Hz be an object of the linear prediction analysis, the signal sⱼ is input to the lattice filter with a white noise having a signal-to-noise ratio of 0 dB being added thereto. Since the forward prediction error fⱼ(M) of the last stage of the lattice filter is equal to a difference between the signal sⱼ and a prediction synthesis signal s′ⱼ, the signal s′ⱼ is given as the following formula.

s′ⱼ=(sⱼ+nⱼ)−fⱼ(M) (8)

Then, the analytic performance of the forward prediction error fⱼ(M) of the last stage is calculated from the following formula, and is compared with that calculated by the time-update recursion.

$${E}_{n} = 10 {log}_{10} \{ {\sum }_{j = nJ + 1}^{( n + 1 ) J} {( {s}_{j}^{′} - {s}_{j} )}^{2} / {\sum }_{j = nJ + 1}^{( n + 1 ) J} {s}_{j}^{2} \} \qquad ( 9 )$$

In the above-described formula (9), M (number of taps)=256, μ (step size)=0.01, and J (average period)=8192.

From the results of this simulation, it is confirmed that the prediction error calculated by the linear prediction analysis according to the present invention converges faster than that calculated by the time-update recursion. Further, it is also confirmed that the prediction error calculated by the linear prediction analysis has a prediction performance almost equal to that of the prediction error calculated by the time-update recursion.

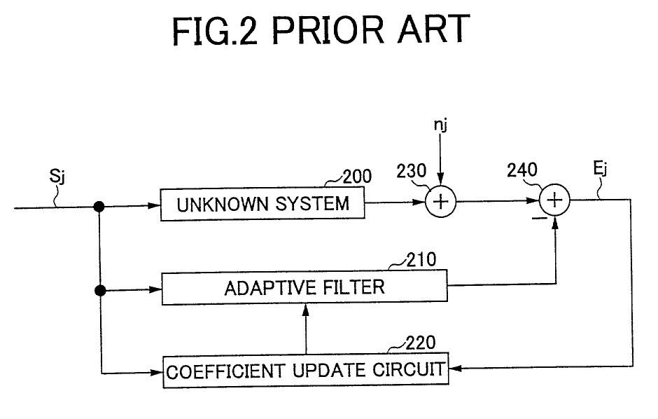

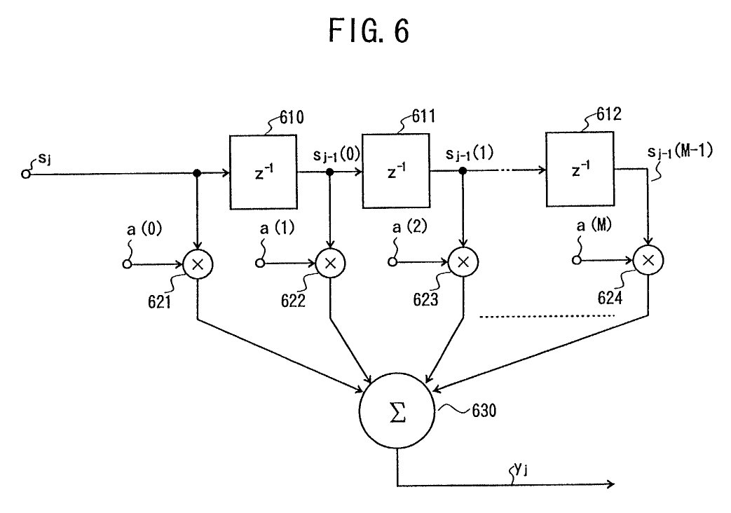

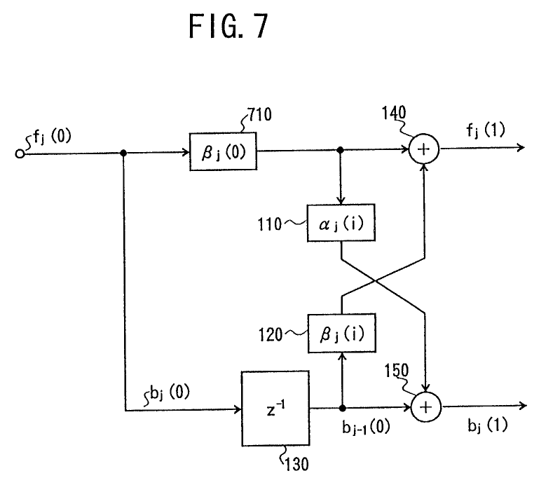

A description will now be given of a third embodiment of the present invention, in which embodiment the present invention is applied to the system identification system shown in FIG. 2. FIG. 6 is a diagram showing a circuit structure of the unknown system 200 shown in FIG. 2 in the case of an assumption that the unknown system 200 can be represented by an FIR filter. This assumption is made only to simplify a description given below. In FIG. 6, the FIR filter includes delay elements 610 through 612 each delaying an input signal by one sampling period, multipliers 621 through 624, and an adder 630. The signal sⱼ is input to the delay element 610 and the multiplier 621. A difference between the circuit structures of FIGS. 4 and 6 lies in that the output of the multiplier 420 is the signal sⱼ, while the output of the multiplier 621 is a signal a(0)sⱼ. Therefore, by adding a multiplier 710 which multiplies the forward prediction error fⱼ(0) by a forward reflection coefficient βⱼ(0) to the first stage of the lattice filter of FIG. 1 as shown in FIG. 7, the circuits of FIGS. 6 and 7 are allowed to have the same structure.

The lattice filter is modified to have the above-described structure, so that the forward prediction error fⱼ(M) of the lattice filter corresponds to an output yⱼ of the unknown system 200. Further, the forward reflection coefficient βⱼ(i) of the lattice filter employed as an adaptive filter is updated by means of an adaptive algorithm so that an error eⱼ is minimized in the following formula, and the forward reflection coefficient βⱼ(i) is used for the backward reflection coefficient αⱼ(i).

eⱼ=yⱼ+nⱼ−fⱼ(M) (10)

Thereby, the lattice filter can identify the unknown system 200.

A description will now be given of a fourth embodiment of the present invention, in which embodiment the lattice filter according to the present invention is applied to the above-described system identification system in which the unknown system 200 can be represented by the FIR filter.

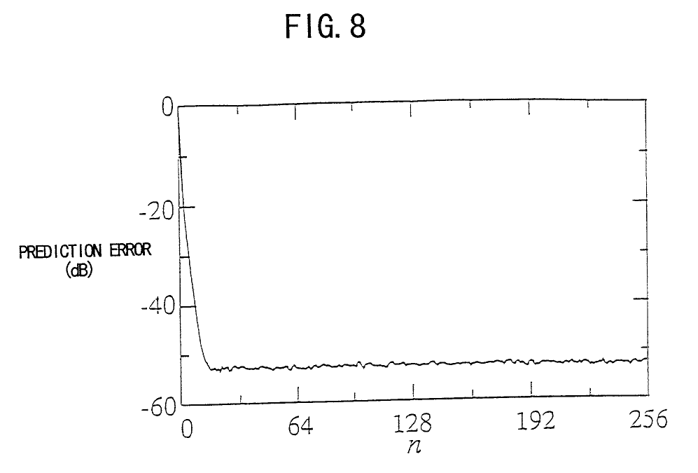

FIG. 8 is a graph showing the results of a simulation of the fourth embodiment. The conditions of this simulation are M=256, μ=0.01, and J=4096. According to the results of this simulation, the obtained prediction error is sufficiently small so that it is confirmed that the lattice filter according to the present invention can be applied to the system identification system.

Further, according to this embodiment, the characteristic of the FIR filter can be realized by the lattice filter. Normally, it requires a large number of calculations to replace the characteristic of the FIR filter with the lattice filter. However, by employing the designed FIR filter instead of the unknown system 200 in the system identification system shown in FIG. 2 so as to update the reflection coefficients of the lattice filter by the coefficient update circuit 220 as described above, the lattice filter having the characteristic of the FIR filter can be obtained.

A description will now be given of a fifth embodiment of the present invention, in which embodiment the unknown system 200 shown in FIG. 2 is represented by the lattice filter.

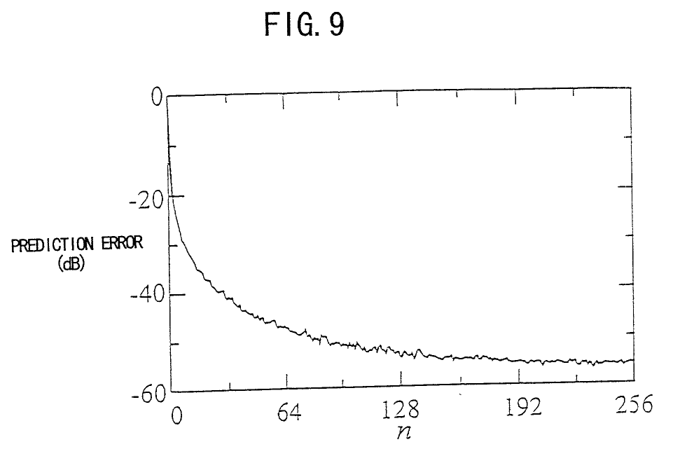

FIG. 9 is a graph showing the results of a simulation of the fifth embodiment. The conditions of this simulation are equal to those of the simulation of FIG. 5 except that a signal-to-noise ratio is set at 20 dB in the simulation of FIG. 9. According to the results of this simulation, the obtained prediction error is sufficiently small so that it is confirmed that the lattice filter according to the present invention can be applied to the system identification system.

A description will now be given of a sixth embodiment of the present invention, in which embodiment the lattice filter according to the present invention is employed as an adaptive filter of a system identification system which identifies a reverse characteristic of an unknown system.

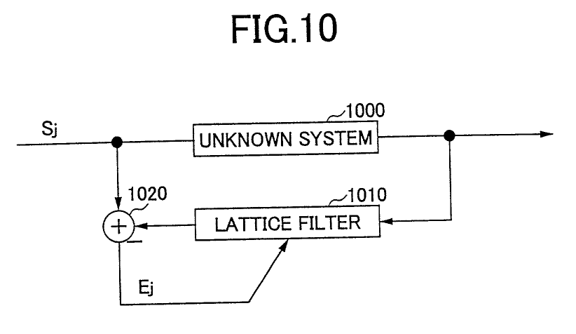

FIG. 10 is a diagram showing a system identification system to which the lattice filter according to the present invention is applied so that a lattice filter 1010 is employed as an adaptive filter for identifying a reverse characteristic of an unknown system 1000. The output of the unknown system 1000 is input to the lattice filter 1010, and a subtracter 1020 calculates a difference between an input to the unknown system 1000 and the output of the lattice filter 1010. The backward and forward reflection coefficients αⱼ(i) and βⱼ(i) are determined as described above according to the present invention so as to minimize the output of the subtracter 1020, so that the lattice filter 1010 can identify the unknown system 1000.

The principle of the present invention is to minimize a difference between the forward prediction error obtained at the last stage of the lattice filter and a desired response (output of an unknown system in such a system identification system as is described above). Therefore, it is apparent that the principle of the present invention is applicable to a system identification system having a desired response other than the systems described above.

The present invention is not limited to the specifically disclosed embodiments, but variations and modifications may be made without departing from the scope of the present invention.

The present application is based on Japanese priority application No. 2000-067787 filed on Mar. 10, 2000, the entire contents of which are hereby incorporated by reference.

What is claimed is:

1. A method of updating reflection coefficients of a lattice filter, comprising the step of updating backward reflection coefficients by employing forward reflection coefficients which are updated so that a forward prediction error of a last stage of the lattice filter is minimized.

2. A method of updating reflection coefficients of a lattice filter, comprising the steps of:
(a) calculating a forward prediction error;
(b) updating forward reflection coefficients in accordance with an adaptive algorithm so as to minimize the forward prediction error of a last stage of the lattice filter; and
(c) applying the forward reflection coefficients updated in said step (b) to backward reflection coefficients.

3. A method of updating reflection coefficients of a lattice filter, comprising the step of updating backward reflection coefficients by employing forward reflection coefficients which are updated so as to minimize a difference between a forward prediction error of a last stage of the lattice filter to which an input or output of an unknown system is supplied, and the output or input of the unknown system.

4. A method of updating reflection coefficients of a lattice filter, comprising the steps of:
(a) calculating a forward prediction error of the lattice filter to which an input or output of an unknown system is supplied;
(b) updating forward reflection coefficients in accordance with an adaptive algorithm so as to minimize a difference between the forward prediction error of a last stage of the lattice filter and the output or input of the unknown system; and
(c) applying the forward reflection coefficients updated in said step (b) to backward reflection coefficients.

5. An apparatus for updating reflection coefficients of a lattice filter, comprising:
a first circuit which calculates a forward prediction error;
a second circuit which updates forward reflection coefficients in accordance with an adaptive algorithm so as to minimize the forward prediction error of a last stage of the lattice filter; and
a third circuit which applies the forward reflection coefficients updated by said second circuit to backward reflection coefficients.

6. An apparatus for updating reflection coefficients of a lattice filter, comprising:
a first circuit which calculates a forward prediction error of the lattice filter to which an input or output of an unknown system is supplied;
a second circuit which updates forward reflection coefficients in accordance with an adaptive algorithm so as to minimize a difference between the forward prediction error of a last stage of the lattice filter and the output or input of the unknown system; and
a third circuit which applies the forward reflection coefficients updated by said second circuit to backward reflection coefficients.
